(19) United States
(12) Patent Application Publication
(10) Pub. No.: US 2026/0254374 A1
(43) Pub. Date: Aug. 27, 2026

(54) ELECTRIC GENERATOR

(71) Applicant: Tamer Technologies, Inc., Poquoson, VA (US)

(72) Inventors: Robert W. MOSES, Poquoson, VA (US); Adam J. DUZIK, Newport News, VA (US)

(73) Assignee: Tamer Technologies, Inc., Poquoson, VA (US)

(21) Appl. No.: 19/547,117

(22) Filed: Feb. 23, 2026

Related U.S. Application Data
(60) Provisional application No. 63/762,531, filed on Feb. 24, 2025.

(51) Int. Cl. H02N 11/00

(52) U.S. Cl. CPC H02N 11/002

(57) ABSTRACT

An electric generator may include: a base layer and a collector layer including electrically conductive material; a plurality of emitters formed by 3D printing between the base and collector layers, each emitter having an emitter base in contact with the base layer and an emitter tip; and a plurality of support posts extended between the base and collector layers in contact with the base layer and the collector layer at opposite ends of each support post and having a support post height greater than an emitter height so as to form an emitter gap between the emitter tip and the collector layer, wherein each emitter is configured so that, based on an excitation, electrons in the base layer move to the emitter tip and travel across the emitter gap to the collector layer so as to form an electrical current flow path between the emitters and the collector layer.

### CROSS REFERENCE TO RELATED APPLICATIONS

The present application claims the benefit of the filing date of United States Provisional Application No. 63/762,531, filed February 24, 2025, the contents of which is incorporated herein in its entirety by reference.

### BACKGROUND

Waste energy scavenging presents a promising opportunity to reduce the world’s dependence on non-renewable energy sources by increasing energy efficiency of existing technologies and/or by providing access to energy, that based on existing technologies, is considered waste. For example, scavenging of waste thermal energy using a thermoelectric generator (TEG) which depends on a temperature difference to generate electricity may require arranging the TEG in such a way as to create a large temperature difference in order to drive generation of electricity. However, as potential energy sources may exceed 500 °C or more, few materials may be available for the construction of such devices.

Furthermore, higher temperature energy sources (e.g., ~1,000 °C) may be completely untapped due to material limitations, and/or difficulty and cost of fabrication.

### BRIEF DESCRIPTION OF THE DRAWINGS

The foregoing and other objects, features, and advantages of the disclosure will be apparent from the following description of particular examples of the disclosure, as illustrated in the accompanying drawings in which like reference characters refer to the same parts throughout the different views. The drawings are not necessarily to scale, emphasis instead being placed upon illustrating the principles of the disclosure.

FIG. 1 – is a schematic illustration of a side view of an electric generator;

FIG. 2 – is a schematic illustration of a side view of an electric generator having a field emission electrode;

FIG. 3 – schematic illustration of a top view of the A-A cross-section of the electric generator of FIG. 2;

FIG. 4 – is a schematic illustration of a side view of emitters of varying shape;

FIG. 5 – is a schematic illustration of a side view of a multi-layered electric generator;

FIG. 6 – is a schematic illustration of a method as disclosed herein; and

FIG. 7 – is a schematic illustration of a computing apparatus to control and interface with the disclosed electric generator.

### DETAILED DESCRIPTION

In accordance with the present disclosure, an electric generator may include: a base layer including a first electrically conductive material; a collector layer including a second electrically conductive material; a plurality of emitters formed by 3D printing between the base layer and the collector layer, each emitter of the plurality of emitters having an emitter base, and an emitter tip extended from the emitter base by an emitter height, the emitter base being in contact with the base layer and having an emitter base cross-sectional area, and the emitter tip having an emitter tip cross-sectional area that is less than or equal to the emitter base cross-sectional area, wherein the plurality of emitters include a third electrically conductive material; and a plurality of support posts extended between the base layer and the collector layer, each support post of the plurality of support posts: in contact with the base layer and the collector layer at opposite ends of each support post, including an electrically insulative material, and having a support post height greater than the emitter height so as to form an emitter gap between the emitter tip of each emitter of the plurality of emitters and the collector layer, wherein each emitter of the plurality of emitters is configured so that, based on an excitation, electrons in the base layer move to the emitter tip, and the electrons then travel across the emitter gap to the collector layer so as to form an electrical current flow path between the plurality of emitters and the collector layer.

In accordance with the present disclosure, each emitter of the plurality of emitters includes an aspect number of the emitter height divided by an average width of each emitter, and each emitter of the plurality of emitters has an aspect number that is greater than or equal to about 2.

In accordance with the present disclosure, the first electrically conductive material and the third electrically conductive material are different materials.

In accordance with the present disclosure, the first electrically conductive material and the second electrically conductive material are different materials.

In accordance with the present disclosure, the second electrically conductive material and the third electrically conductive material are different materials.

In accordance with the present disclosure, the first electrically conductive material, the second electrically conductive material, and the third electrically conductive material are different materials.

In accordance with the present disclosure, a fraction of a number of emitters of the plurality of emitters divided by a number of support posts of the plurality of support posts is less than or equal to about 100 and greater than or equal to about 5.

In accordance with the present disclosure, support posts of the plurality of support posts are interspersed among the plurality of emitters, and a distance between each support post of the plurality of support posts is greater than or equal to about 0.5 mm and less than or equal to about 10 mm.

In accordance with the present disclosure, the emitter gap has a gap distance that is greater than or equal to about 1 μm and less than or equal to about 20 mm.

In accordance with the present disclosure, at least one of the first electrically conductive material and the third electrically conductive material include mayenite in an electride phase.

In accordance with the present disclosure, at least one of the first electrically conductive material and the third electrically conductive material include strontium vanadate.

In accordance with the present disclosure, the electric generator may further include an insulation layer, wherein a first side of the insulation layer is in contact with a side of the collector layer opposite of the plurality of emitters, the insulation layer including another electrically insulative material so as to prevent electrons from transferring from the side of the collector layer to the first side of the insulation layer.

In accordance with the present disclosure, the electric generator may further include a field emission electrode between the base layer and the collector layer and including a plurality of openings respectively corresponding to the plurality of emitters and configured so that at least a portion of each emitter of the plurality of emitters passes through each opening of the plurality of openings.

In accordance with the present disclosure, a method may include: by at least one 3D printer, printing a plurality of emitters onto a base layer of a first electrically conductive material, each emitter of the plurality of emitters having an emitter base, and an emitter tip extended from the emitter base by an emitter height, the emitter base being in contact with the base layer and having an emitter base cross-sectional area, and the emitter tip having an emitter tip cross-sectional area that is less than or equal to the emitter base cross-sectional area, wherein the plurality of emitters include a third electrically conductive material; and printing a plurality of support posts including an electrically insulative material, onto the base layer, each support post of the plurality of support posts being in contact with the base layer at a first end of each support post, each support post of the plurality of support posts having a support post height greater than the emitter height; layering a collector layer including a second electrically conductive material onto a second end of the plurality of support posts opposite the first end so that, with the collector layer layered onto the plurality of support posts, an emitter gap between the emitter tip of each emitter of the plurality of emitters and the collector layer is formed, and so that, based on an excitation, electrons in the base layer move to the emitter tip, and the electrons then travel across the emitter gap to the collector layer so as to form an electrical current flow path between the plurality of emitters and the collector layer.

In accordance with the present disclosure, the method may further include printing, by a third 3D printer, the base layer onto a removable substrate.

In accordance with the present disclosure, the first 3D printer and the second 3D printer are a same printer.

In accordance with the present disclosure, the method may further include layering an insulating layer including an electrically insulative material onto the collector layer.

In accordance with the present disclosure, the method may further include before the layering the collector layer, layering a filler material in spaces between emitters of the plurality of emitters and/or between support posts of the plurality of support posts; and removing the layered filler material from the spaces after the layering the collector layer.

In accordance with the present disclosure, the layering the filler material includes printing, by a fourth 3D printer, the filler material.

In accordance with the present disclosure, the layering the collector further includes printing, by a fifth 3D printer, the collector layer onto the filler material and the second end of each support post of the plurality of support posts.

In accordance with the present disclosure, a method of operating an electric generator including a base layer including a first electrically conductive material; a collector layer including a second electrically conducive material; a plurality of emitters between the base layer and the collector layer, each emitter of the plurality of emitters having an emitter base, and an emitter tip extended from the emitter base by an emitter height, the emitter base being in contact with the base layer and having an emitter base cross-sectional area, and the emitter tip having an emitter tip cross-sectional area that is less than or equal to the emitter base cross-sectional area, wherein the plurality of emitters include a third electrically conductive material and are obtained by 3D printing; the electric generator further including a plurality of support posts extended between the base layer and the collector layer, each support post of the plurality of support posts in contact with the base layer and the collector layer at opposite ends of each support post, including an electrically insulative material, and having a support post height greater than the emitter height so as to form an emitter gap between the emitter tip of each emitter of the plurality of emitters and the collector layer, the method may include: connecting a first electrical conductor to the base layer; connecting a second electrical conductor to the collector layer; connecting a first terminal of an energy consumer to the first electrical conductor and a second terminal of the energy consumer to the second electrical conductor so as to form an electrical circuit including the base layer, the plurality of emitters, the emitter gap, the collector layer, the second electrical conductor, the energy consumer, and the first electrical conductor; and exposing the base layer to an excitation so that electrons in the base layer move to the emitter tip, move across the emitter gap to the collector layer, move through the second electrical conductor, move through the energy consumer, move through the first electrical conductor, and then move back to the base layer so as to form a flow of electrical current that travels along the electrical circuit.

In accordance with the present disclosure, the excitation includes at least one of a heat source and a high energy photon radiation source.

In accordance with the present disclosure, the electric generator may further include a field emission electrode between the base layer and the collector layer and including a plurality of openings respectively corresponding to the plurality of emitters and configured so that at least a portion of each emitter of the plurality of emitters passes through each opening of the plurality of openings, and the method may further include: applying a voltage to the field emission electrode so as to control the movement of electrons across the emitter gap and thereby control the flow of electrical current along the electrical circuit.

In accordance with the present disclosure, the electric generator may further include a multilayer stacked architecture so that the base layer further includes a first base layer and a second base layer, the collector layer further incudes a first collector layer electrically connected to the second base layer and a second collector layer, the plurality of emitters includes a first plurality of emitters between the first base layer and the first collector layer and a second plurality of emitters between the second base layer and the second collector layer, and the emitter gap includes a first emitter gap between the first plurality of emitters and the first collector layer and a second emitter gap between the second plurality of emitters and the second collector layer, the connecting the first electrical conductor to the base layer incudes connecting the first electrical conductor to the first base layer, the connecting the second electrical conductor to the collector layer incudes connecting the second electrical conductor to the second conductor layer, the connecting the first terminal of the energy consumer to the first electrical conductor and the connecting the second terminal of the energy consumer to the second electrical conductor forms an electrical circuit including, in order, the first base layer, the first plurality of emitters, the first emitter gap, the first collector layer, the second base layer, the second plurality of emitters, the second emitter gap, the second collector layer, the second electrical conductor, the energy consumer, and the first electrical conductor, and exposing includes exposing at least the first base layer to an excitation so that electrons in the first base layer move across the first emitter gap to the first collector layer, move from the first collector layer to the second base layer, move from the second base layer across the second emitter gap to the second collector layer, move through the second electrical conductor, move through the energy consumer, move through the first electrical conductor, and then move back to the first base layer so as to form the flow of electrical current that travels serially along the electrical circuit.

In accordance with the present disclosure, the electric generator may further include a stacked or shifted architecture so that the base layer further includes a first base layer and a second base layer, the collector layer further incudes a first collector layer and a second collector layer, the plurality of emitters includes a first plurality of emitters between the first base layer and the first collector layer and a second plurality of emitters between the second base layer and the second collector layer, and the emitter gap includes a first emitter gap between the first plurality of emitters and the first collector layer and a second emitter gap between the second plurality of emitters and the second collector layer, the first base layer, the first collector layer, the first plurality of emitters, and the first emitter gap are electrically isolated from the second base layer, the second collector layer, the second plurality of emitters, and the second emitter gap, the connecting the first electrical conductor to the base layer incudes connecting the first electrical conductor to the first base layer, the connecting the second electrical conductor to the collector layer incudes connecting the second electrical conductor to the first conductor layer, the method further includes: connecting a third electrical conductor to the second base layer, connecting a fourth electrical conductor to the second collector layer, connecting the first terminal of the energy consumer to the first electrical conductor and the third electrical conductor and connecting the second terminal of the energy consumer to the second electrical conductor and the fourth electrical conductor forms two parallel electrical circuits including a first electrical circuit including, in order, the first base layer, the first plurality of emitters, the first emitter gap, the first collector layer, the second electrical conductor, the energy consumer, and the first electrical conductor, and a second electrical circuit including, in order, the second base layer, the second plurality of emitters, the second emitter gap, the second collector layer, the fourth electrical conductor, the energy consumer, and the third electrical conductor, and exposing includes exposing the first base layer and the second base layer to an excitation so that electrons in the first base layer move across the first emitter gap to the first collector layer, move through the second electrical conductor, move through the energy consumer, move through the first electrical conductor, and then move back to the first base layer so as to form a first flow of electrical current that travels along the electrical circuit, and electrons in the second base layer move across the second emitter gap to the second collector layer, move through the fourth electrical conductor, move through the energy consumer, move through the third electrical conductor, and then move back to the second base layer so as to form a second flow of electrical current that travels along the electrical circuit and that is at least partially parallel to the first flow of electrical current.

Disclosed herein is an electric generator 100 that may be used to produce electrical power. For example, the electric generator 100 may produce direct current (DC) power based on an excitation of components of the electric generator 100 which produces a motive force to move electrons from a positive terminal of the electric generator 100 (e.g., cathode) to a negative terminal of the electric generator 100 (e.g., anode), thereby producing an electrical current flow through the device. The excitation that results in the electrical current flow may include excitation by electromagnetic radiation (e.g., photon impact causing a photoionic effect, thermal impact causing a thermionic effect, and the like) or exposure to electric fields on a material of the electric generator that is sufficient to overcome the work function of the material and/or material surface so as to cause an electron emission from the surface of the material. The electrical current flow may be utilized to power an energy consumer through an electrical circuit. The present disclosure meets challenges with energy scavenging devices by providing novel constructions and novel materials of construction. Regarding novel constructions, as disclosed herein, the electric generator 100 may be constructed with micro-scale and/or nano-scale features by utilizing micro-fabrication and/or nano-fabrication techniques such as additive manufacturing. Regarding novel materials of construction, as disclosed herein, the electric generator 100 may include materials that are capable of operating in higher temperature environments and/or may have, and/or be configured into shapes having, relatively small work functions in comparison to other materials (e.g., such as tungsten (W), lanthanum hexaboride (LaB₆), diamond (C), mayenite in an electride phase, and strontium vanadate (SrVOₓ)).

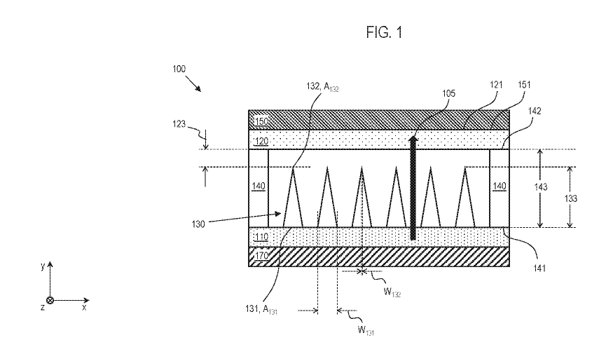

With reference to FIG. 1, the electric generator 100 may include a base layer 110, a collector layer 120, a plurality of emitters 130, and a plurality of support posts 140. The base layer 110 may be spaced apart from the collector layer 120. The plurality of emitters 130 and the plurality of support posts 140 may be between the base layer 110 and the collector layer 120.

When an excitation (e.g., described below) at the base layer 110 occurs, electrons in the base layer 110 may move to an emitter tip 132 (e.g., which may thereby increase an electron density at the emitter tip 132), and travel across an emitter gap 123 to be received at the collector layer 120 so as to form an electrical current flow path 105 between the base layer 110 and the collector layer 120. Accordingly, when an energy consumer is connected to the electric generator 100 (e.g., by way of conductors connected to the base layer 110 and the collector layer 120), direct current (DC), corresponding to the number of electrons traveling along the electrical current flow path 105, may flow from the collector layer 120, through the energy consumer, and back to the base layer 110. In this way, the electric generator 100 may generate a DC current that corresponds to a magnitude of the excitation that causes electrons to cross the emitter gap 123.

The plurality of emitters 130 may be arranged on the base layer 110 and extend toward the collector layer 120. The plurality of emitters 130 may include uniform, or non-uniform, emitters. Although each emitter of the plurality of emitters 130 may be non-uniformly shaped, may have non-uniform geometries, may be non-uniformly spaced, may include different materials, and/or may be non-uniformly arranged in the electric generator 100, for clarity, throughout the present disclosure the plurality of emitters 130 will be described as though each emitter of the plurality of emitters 130 has the same shape, geometry, spacing, materials, and arrangement.

Each emitter of the plurality of emitters 130 has an emitter base 131 (e.g., a first end), and an emitter tip 132 (e.g., a second end) extended from the emitter base 131 by an emitter height 133. The emitter base 131 may be in contact with the base layer 110. For example, the emitter base 131 may be in direct physical contact (e.g., joined) with the base layer 110. For further example, a surface of the emitter base 131 may be in union with, and/or form a junction with, a surface of the base layer 110.

Each emitter has an emitter base cross-sectional area A₁₃₁ and an emitter tip cross-sectional area A₁₃₂corresponding to the cross-sectionalarea of the at the emitter base 131 and the emitter tip 132, respectively. For example, the emitter base cross-sectional area A₁₃₁ may be defined by the area of a cross-sectional shape of the emitter base 131 where the emitter base 131 is in contact with the base layer 110 (e.g., the area of the cross-sectional shape of the emitter at the emitter base 131 in the x-z plane of the attached FIGS). Similarly, the emitter tip cross-sectional area A₁₃₂ may be defined by the area of a cross-sectional shape of the emitter tip 132 at the tip of the emitter (e.g., the area of the cross-sectional shape of the emitter at the emitter tip 132 in the x-z plane of the attached FIGS). Each emitter may be tapered from the emitter base 131 to the emitter tip 132. In particular, the emitter base cross-sectional area A₁₃₁ may be greater than or equal to the emitter tip cross-sectional area A₁₃₂(e.g., A₁₃₁ ≥ A₁₃₂). Specifically, the emitter base cross-sectional area A₁₃₁ may be about 1 to about 1000 times greater, or about 1 to about 500 times greater, or about 1 to about 250 times greater, or about 1 to about 200 times greater, or about 1 to about 150 times greater, or about 1 to about 100 times greater, or about 1 to about 75 times greater, or about 1 to about 50 times greater, or about 1 to about 40 times greater, or about 1 to about 30 times greater, or about 1 to about 25 times greater, or about 1 to about 20 times greater, or about 1 to about 15 times greater, or about 1 to about 10 times greater, or about 1 to about 5 times greater, or about 1 to about 3 times greater, or about 1 to about 2.5 times greater than the emitter tip cross-sectional area A₁₃₂.

In other words, the emitter tip cross-sectional area A₁₃₂ may be less than or equal to the emitter base cross-sectional area A₁₃₁. Specifically, the emitter tip cross-sectional area A₁₃₂ may be about 1 to about 1000 times less, or about 1 to about 500 times less, or about 1 to about 250 times less, or about 1 to about 200 times less, or about 1 to about 150 times less, or about 1 to about 100 times less, or about 1 to about 75 times less, or about 1 to about 50 times less, or about 1 to about 40 times less, or about 1 to about 30 times less, or about 1 to about 25 times less, or about 1 to about 20 times less, or about 1 to about 15 times less, or about 1 to about 10 times less, or about 1 to about 5 times less, or about 1 to about 3 times less, or about 1 to about 2.5 times less than the emitter base cross-sectional area A₁₃₁.

Due, at least in part, to the difference in the cross-sectional area of the emitter base 131 and the emitter tip 132, the emitter tip 132 may have a higher electron density than at the emitter base 131 (e.g., during operation as electrons move to the emitter tip 132). Further the likelihood of electrons crossing the emitter gap 123 may be related to a work function of the emitter. The work function may be defined as the minimum energy required to remove an electron from a surface of a solid material to infinity (e.g., so far away from the surface that electrostatic attraction, that keeps the electron in the material, is overcome). In other words, the electron is at a lower energy state in the material due to electrostatic attraction. Thus, external energy (e.g., thermal or photon energy) is necessary to remove the electron from the material. The energy needed for the removal is the work function of the material. The work function may be based on the shape and/or type of the solid material (e.g., the shape of the emitter and/or the emitter material). When materials and/or shapes having a relatively low work function are employed in the emitter, the magnitude of the excitation needed to drive (e.g., create a current flow through) the electric generator 100 may be reduced in comparison to materials and/or shapes having a higher work function.

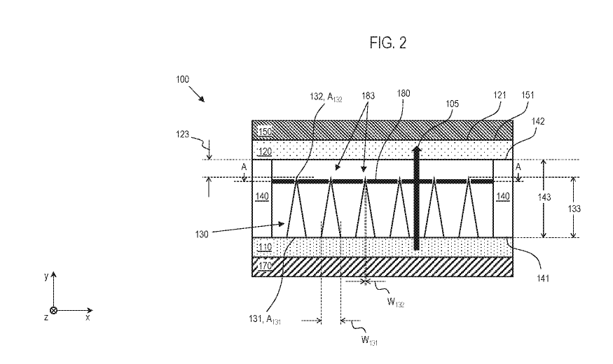

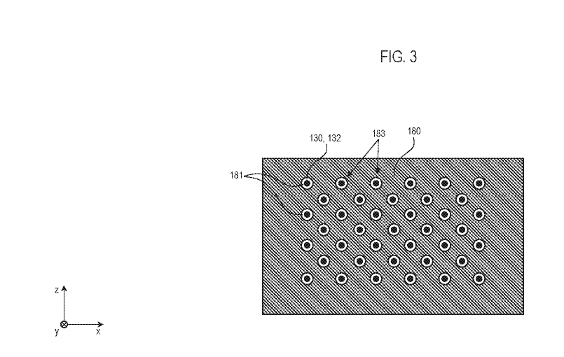

With reference to FIG. 2, the electric generator 100 may further include a field emission electrode 180. The field emission electrode 180 may be spaced apart from the base layer 110, the collector layer 120, and the plurality of emitters 130. The field emission electrode 180 may be between the base layer 110 and the collector layer 120. The field emission electrode 180 may include opening though which emitters of the plurality of emitters 130 extend. For example, the field emission electrode 180 may include a plurality of opening 183 respectively corresponding to the plurality of emitters 130. The field emission electrode 180 may be configured so that emitter tips 132 of the plurality of emitters 130 extend into and/or through openings of the plurality of opening 183. In this way, there may be a field emission electrode gaps 181 between emitter tips 132 of the plurality of emitters 130 and the openings of the plurality of opening 183. For example, the field emission electrode 180 may be configured so that an emitter tip 132 of each emitter of the plurality of emitters 130 passes into (e.g., and through) each opening of the plurality of opening 183 (such as in FIG. 3 which shows a cross-sectional view of the electric generator 100 taken along the A-A line of FIG. 2).

In operation, the field emission electrode 180 may be used to add a voltage bias (e.g., forward bias or reverse bias) to the plurality of emitters 130 so as to control the flow of electrons from the plurality of emitters 130 to the collector layer 120 (e.g., by providing a separate influence on the band structure of the material). For example, a positive voltage bias, relative to the voltage of the plurality of emitters 130, may be applied to the field emission electrode 180 (e.g., the field emission electrode 180 having a higher voltage than the plurality of emitters 130) which may stimulate the flow of electrons across the emitter gap 123 from the plurality of emitters 130 to the collector layer 120 as electrons are drawn away from the plurality of emitters 130 by the more positive field emission electrode 180. Alternatively, a negative voltage bias, relative to the voltage of the plurality of emitters 130, may be applied to the field emission electrode 180 (e.g., the field emission electrode 180 having a lower voltage than the plurality of emitters130) which may slow, or stop, the flow of electrons across the emitter gap 123 from the plurality of emitters 130 to the collector layer 120 as the field emission electrode 180 causes a repulsive negative electric field that suppresses movement of electrons away from the plurality of emitters 130. Further, no biasing voltage may be applied to the field emission electrode 180 relative to the plurality of emitters 130 (e.g., where the field emission electrode has neither a positive nor negative voltage relative to the voltage of the plurality of emitters 130) so that flow of electrons from the plurality of emitters 130 to the collector layer 120 is not influenced by the field emission electrode 180

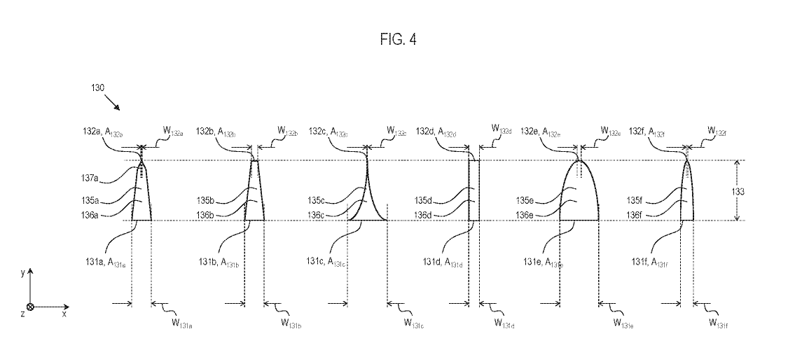

FIG. 4 shows examples of various emitter shapes in a side view (e.g., in the x-y plane of the attached FIGS). The side view shape of each emitter may include a triangle, trapezoid, needle, rectangle, parabola, and the like, and a combination including one or more of the foregoing. The emitter shapes shown in FIG. 4 are simply shown as examples and are not meant to be limiting.

For example, a first emitter shape 135a may include a trapezoid section 136a and a triangle section 137a. The trapezoid section 136a may be a lower section, closer to the base layer 110 than the triangle section 137a, and the triangle section 137a may be an upper section, closer to the collector layer 120 than the trapezoid section 136a. Vertical surfaces of the trapezoid section 136a (e.g., the left and right surfaces in the FIG) may slope inward toward a center of the emitter with a first slope (e.g., in the x-y plane of the FIG) and the vertical surfaces of the triangle section 137a (e.g., the left and right surfaces in the FIG) may slope inward toward a center of the emitter with a second slope (e.g., in the x-y plane of the FIG) less steep in comparison to the first slope (e.g., an absolute value of the second slope being smaller than an absolute value of the first slope). The emitter base 131a may have a width W₁₃₁ₐ and a cross-sectional area A₁₃₁ₐand the emitter tip 132a may have a width W₁₃₂ₐ and a cross-sectional area A_{132a.} The cross-sectional area A₁₃₂ₐ of the emitter tip may be less than the cross-sectional area of the emitter base A₁₃₁ₐ. An average width of the emitter may be equal to the sum of the width W₁₃₁ₐand the width W₁₃₂ₐ divided by two.

A second emitter shape 135b may include a trapezoid section 136b having a larger side at the emitter base 131b and a smaller side at the emitter tip 132b. Accordingly, the cross-sectional area at the emitter tip A_{132b} is less than the cross-sectional area at the emitter base A_{131b}. The emitter base 131b may have a width W_{131b} and a cross-sectional area A_{131b} and the emitter tip 132b may have a width W_{132b} and a cross-sectional area A_{132b.} The cross-sectional area A_{132b} of the emitter tip may be less than the cross-sectional area of the emitter base A_{131b}. An average width of the emitter may be equal to the sum of the width W_{131b} and the width W_{132b} divided by two.

A third emitter shape 135c may include a needle (or needle-like) section 136c. Vertical surfaces of the needle section 136c may have slopes that change as a function of the emitter height 133 (e.g., in the y-axis direction of the FIG). For example, an absolute value of the slopes (e.g., in the x-y plane of the FIG) of the vertical surfaces at and/or near the emitter base 131c may be smaller than the absolute value of the slopes (e.g., in the x-y plane of the FIG) of the vertical surfaces at and/or near the emitter tip 132c. In other words, the slope of the vertical surfaces may change from a gentler slope at/near the emitter base 131c to a more aggressive slope near the emitter tip 132c. Accordingly, the emitter tip 132c of the third emitter shape 135c may approximate a needle (e.g., having a cross-sectional area at the emitter tip A_{132c} that is much less than the cross-section area at the emitter base A_{131c}). The emitter base 131c may have a width W_{131c} and a cross-sectional area A_{131c}and the emitter tip 132c may have a width W_{132c} and a cross-sectional area A_{132c.} The cross-sectional area A_{132c} of the emitter tip may be less than the cross-sectional area of the emitter base A_{131c}. An average width of the emitter may be equal to the sum of the width W_{131c} and the width W_{132c} divided by two.

A fourth emitter shape 135d may include a rectangle section 136d where the sides at the emitter base 131d and the emitter tip 132d are about equal to one another. Accordingly, the cross-sectional area at the emitter tip A_{132d} may be about equal to the cross-sectional area at the emitter base A_{131d}. The emitter base 131d may have a width W_{131d} and a cross-sectional area A_{131d} and the emitter tip 132d may have a width W_{132d} and a cross-sectional area A_{132d.} The cross-sectional area A_{132d} of the emitter tip may be less than the cross-sectional area of the emitter base A_{131d}. An average width of the emitter may be equal to the sum of the width W_{131d} and the width W_{132d} divided by two.

A fifth emitter shape 135e may include a first parabola section 136e. The vertical surfaces of the first parabola section 136e may have, at least a portion, that includes a gradually changing slope (e.g., in the x-y plane of the FIG). Accordingly, the emitter tip 132e of the fifth emitter shape 135e may be blunter in comparison to a needle shape and may approximate a shape of a bullet (e.g., having a cross-sectional area at the emitter tip A₁₃₂ₑ that is closer to the cross-section area at the emitter base A₁₃₁ₑ in comparison to the cross-sectional areas of the tip and base of the needle shape). The emitter base 131e may have a width W₁₃₁ₑ and a cross-sectional area A₁₃₁ₑ and the emitter tip 132e may have a width W₁₃₂ₑ and a cross-sectional area A_{132e.} The cross-sectional area A₁₃₂ₑ of the emitter tip may be less than the cross-sectional area of the emitter base A₁₃₁ₑ. An average width of the emitter may be equal to the sum of the width W₁₃₁ₑ and the width W₁₃₂ₑ divided by two.

A sixth emitter shape 135f may include a second parabola section 136f. The vertical surfaces of the second parabola section 136f may have, at least a portion, that includes an aggressively changing slope (e.g., in the x-y plane of the FIG). Accordingly, the tip 132e of the sixth emitter shape 135f may be sharper in comparison to the first parabola section 136e of the fifth emitter shape 135e, and may also approximate a shape of a bullet albeit a sharper bullet (e.g., a more aerodynamic bullet). Similar to the fifth emitter shape 135e, the sixth emitter shape 135f may have a cross-sectional area at the emitter tip A_{132f} that is closer to the cross-section area at the emitter base A_{131f}in comparison to the cross-sectional areas of the tip and base of the needle shape). The emitter base 131f may have a width W_{131f} and a cross-sectional area A_{131f} and the emitter tip 132f may have a width W_{132f} and a cross-sectional area A_{132f.} The cross-sectional area A_{132f} of the emitter tip may be less than the cross-sectional area of the emitter base A_{131f}. An average width of the emitter may be equal to the sum of the width W_{131f} and the width W_{132f} divided by two.

The cross-sectional shape of an emitter of the plurality of emitters 130 may be any shape (e.g., in the x-z plane of the FIGS). For example, the cross-sectional shape the emitter may include a circle, oval, a triangle, a square, rectangle, the shape of any polygon having straight or curved sides (e.g., a multi-pointed star), and the like. Moreover, the cross-sectional shape of the emitter may include intersecting line segments, such as I-shaped, T-shaped, X-shaped, and the like which may provide greater strength to weight ratio in comparison to other shapes. Accordingly, the cross-sectional area of the emitter may be determined by an area formula associated with the shape, such as may be determined by a two-dimensional integral of the area inside the cross-sectional shape (e.g., in the x-z plane in the attached FIGS).

Furthermore, because the emitter cross-sectional shape may include any shape, the emitter may include more than one width. For example, an emitter having a triangular cross-sectional shape may include three widths corresponding to the three sides of the triangle. In further example, an emitter having a rectangular cross-sectional shape may have two different widths corresponding to the two different length sides of the rectangle. In a still further example, an emitter having a polygonal cross-sectional shape having n different sides (e.g., wherein n is more than one) may have n different widths corresponding to the n different sides of the polygon. Moreover, as the emitter cross-sectional area (e.g., in the x-z plane in the attached FIGS) may change as a function of the emitter height 133 (e.g., from the emitter base cross-sectional area A₁₃₁ to the emitter tip cross-section area A₁₃₂₎, a width of the emitter may also change as a function of the emitter height 133. Therefore, an average emitter width along any side may be used in determining an aspect ratio of an emitter. The average emitter width along a given side may be equal to the sum of an emitter width W₁₃₁ at the emitter base 131 (e.g., on the given side) and an emitter width W₁₃₂ at the emitter tip 132 (e.g., on the given side) divided by two. As used herein, an aspect ratio of an emitter, may refer to the average emitter width (e.g., as discussed in the foregoing) along a side of the emitter to the emitter height 133, and may be expressed as average emitter width:height.

There may be a tradeoff between the structural integrity of the emitter and performance of the emitter (e.g., performance of the emitter as an electron source or electron conveyor). For example, taller and thinner emitters (e.g., smaller tip cross-sectional area) may be able to transfer more electrons per unit area of the plurality of emitters 130 (e.g., due to smaller work functions associated with their geometry) in comparison to shorter and wider emitters (e.g., larger tip cross-sectional area). However, taller and thinner emitters may be more susceptible to mechanical strain and/or stress (e.g., due to thermal cycling fatigue, creep, tension, shear, and the like). Accordingly, the aspect ratio of an emitter of the plurality of emitters 130 may be from about 1:1 to about 1:1,000, or from about 1:1 to about 1:500, or from about 1:1 to about 1:300, or from about 1:1 to about 1:250, or from about 1:1 to about 1:200, or from about 1:1 to about 1:150, or from about 1:1 to about 1:100, or from about 1:1 to about 1:75, or from about 1:1 to about 1:50, or from about 1:1 to about 1:40, or from about 1:1 to about 1:30, or from about 1:1 to about 1:20, or from about 1:1 to about 1:15, or from about 1:1 to about 1:10, or from about 1:1 to about 1:8, or from about 1:1 to about 1:6, or from about 1:1 to about 1:5, or from about 1:1 to about 1:4, or from about 1:1 to about 1:3, or from about 1:1 to about 1:2, or from about 1:1 to about 1:1.5, or from about 1:1.5 to about 1:3, or from about 1:1.5 to about 1:5, or from about 1:1.5 to about 1:10, or from about 1:1.5 to about 1:20, or from about 1:1.5 to about 1:50, or from about 1:1.5 to about 1:100, or 1:greater than or equal to about 2, or 1:greater than or equal to about 5, or 2:greater than or equal to about 5.

Alternatively, as used herein, the aspect ratio may be expressed as a fraction of emitter height divided by an average emitter width (e.g., along any side of the emitter, as discussed in the foregoing), and may be referred to herein as an aspect number. In this case, the aspect number of an emitter of the plurality of emitters 130 may be greater than or equal to about 1. For example, the aspect number may be greater than or equal to about 1.1, or greater than or equal to about 1.2, or greater than or equal to about 1.3, or greater than or equal to about 1.4, or greater than or equal to about 1.5, or greater than or equal to about 1.6, or greater than or equal to about 1.7, or greater than or equal to about 1.8, or greater than or equal to about 1.9, or greater than or equal to about 2, or greater than or equal to about 2.5, or greater than or equal to about 3, or greater than or equal to about 5, or greater than or equal to about 7.5, or greater than or equal to about 10, or greater than or equal to about 20, or greater than or equal to about 50, or greater than or equal to about 100, or greater than or equal to about 200, or greater than or equal to about 500, or greater than or equal to about 750, or greater than or equal to about 1000.

The plurality of emitters 130 may be arranged on the base layer 110 in any pattern with any spacing. For example, the plurality of emitters 130 may be arranged in a square grid pattern, an offset grid pattern (e.g., where the center of mass of emitters in adjacent rows or columns are offset from one another), a circular grid pattern, a spherical pattern (e.g., when the shape of the electric generator 100 is spherical), or any other pattern. With exception for edge emitters (e.g., emitters along the edge of the pattern of the plurality of emitters 130), each emitter of the plurality of emitters 130 may be equally spaced from one another. For example, an edge of the emitter base 131 of each emitter of plurality of emitters 130 may be spaced apart from an edge of the next closest emitter base 131 by about 1 nanometer (nm) to about 10 millimeters (mm), or by about 1 nm to about 5 mm, or about 1 nm to about 4 mm, or about 1 nm to about 3 mm, or about 1 nm to about 2 mm, or about 50 micrometers (μm) to about 2 mm, or about 100 μm to about 2 mm, or about 200 μm to about 2 mm, or about 300 μm to about 2 mm, or about 400 μm to about 2 mm, or about 500 μm to about 2 mm, or about 100 μm to about 1 mm, or about 200 μm to about 1 mm, or about 300 μm to about 1 mm, or about 400 μm to about 1 mm, or about 500 μm to about 1 mm, or about 600 μm to about 1 mm, or about 750 μm to about 1 mm, or less than about 1 mm.

The base layer 110 may include (e.g., may be made of) a first electrically conductive material. The collector layer 120 may include (e.g., may be made of) a second electrically conductive material. The plurality of emitters may include 130 (e.g., may be made of) a third electrically conductive material. The field emission electrode 180 may include (e.g., may be made of) a fourth electrically conductive material. The first electrically conductive material and the second electrically conductive material may be different materials or may be the same materials. The first electrically conductive material and the third electrically conductive material may be different materials or may be the same materials. The first electrically conductive material and the fourth electrically conductive material may be different materials or may be the same materials. The second electrically conductive material and the third electrically conductive material may be different materials or may be the same materials. The second electrically conductive material and the fourth electrically conductive material may be different materials or may be the same materials. The third electrically conductive material and the fourth electrically conductive material may be different materials or may be the same materials. The first electrically conductive material, the second electrically conductive material, the third electrically conductive material, and the fourth electrically conductive material may be different materials or may be the same materials.

At least one of the first electrically conductive material, the second electrically conductive material, the third electrically conductive material, and the fourth electrically conductive material may include (e.g., be made of) at least one material consisting of a metal (e.g., an element in groups 1-12, including the f-block groups, of the periodic table, and including aluminum), a metal-triel (e.g, triel may refer to an element of group 13 of the periodic table), a metal-tetrel (e.g, tetrel may refer to an element of group 14 of the periodic table), a metal-phictogen (e.g, phictogen may refer to an element of group 15 of the periodic table), a metal-chalcogen (e.g, chalcogen may refer to an element of group 16 of the periodic table), and combinations including one or more of the foregoing.

For example, at least one of the first electrically conductive material, the second electrically conductive material, the third electrically conductive material, and the fourth electrically conductive material may include (e.g., be made of) at least one of (e.g., or may include at least one electrically conductive material selected from the group consisting of) an alkali metal (e.g., an element listed in group 1 of the periodic table), an alkaline earth metal (e.g., an element listed in group 2 of the periodic table), a f-block metal (e.g., an element listed in the f-block groups of the periodic table, including lanthanum through ytterbium in period 6, and actinium through nobelium in period 7), a transition metal (e.g., elements listed in groups 3-12 of the periodic table), compounds including at least one of the foregoing metals, and compounds including at least one of the foregoing metals bonded with one or more of a triel, a tetrel, a phictogen, and/or a chalcogen). For example, at least one of the first electrically conductive material, the second electrically conductive material, and the third electrically conductive material may include (e.g., be made of) at least one of (e.g., or may include at least one electrically conductive material selected from the group consisting of) copper, silver, and gold. For example, at least one of the first electrically conductive material, the second electrically conductive material, the third electrically conductive material, and the fourth electrically conductive material may include (e.g., be made of) at least one of (e.g., or may include at least one electrically conductive material selected from the group consisting of) mayenite in an electride phase (e.g., that may include a C12A7 phase, meaning a composition including 12 units of calcium oxide (CaO) to every 7 units of aluminum oxide (Al₂O₃), and that may be represented by the chemical formula Ca₁₂Al₁₄O₃₃, natural deviations in phase composition, and other compositionsof mayenite in the electride phase including parasitic phases), strontium vanadate (e.g., a transition metal perovskite oxide that may be represented by the chemical formula SrVOₓ where x represents variation in the number of oxygen atoms because the number of oxygen atoms in strontium vanadate is not always stoichiometric (e.g., which may be attributed to oxygen vacancies and/or non-stoichiometric levels of elements), in one example the ideal stoichiometry of strontium vanadate may include three oxygen atoms (SrVO₃)), lanthanum hexaboride (LaB₆), tungsten (W), and carbon (C) (e.g., including carbon nanotubes, diamond, and the like). Furthermore, at least one of the first electrically conductive material, the second electrically conductive material, and the third electrically conductive material may include (e.g., be made of) at least one of (e.g., or may include at least one electrically conductive material selected from the group consisting of) any material with a combination of (1) a low work function (e.g., less than about 3.5 electron-volts (eV)), (2) the ability to withstand higher temperature (e.g., greater than or equal to about 500 °C), and (3) the ability to withstand higher radiation associated with radioactive decay such as neutron decay, alpha decay, beta decay, and/or gamma decay (e.g., greater than or equal to about 100 eV, or greater than or equal to about 1 keV, or greater than or equal to about 50 keV, or greater than or equal to about 100 keV, or greater than or equal to about 500 keV, or greater than or equal to about 1 MeV, or greater than or equal to about 50 MeV, or greater than or equal to about 500 MeV, or greater than or equal to about 1 GeV).

To reduce the cost of the electric generator 100 (e.g., the cost of the plurality of emitters 130), relatively expensive materials such as mayenite in an electride phase, and/or strontium vanadate may be included in the emitter tip 132 while the remaining bulk portion of the plurality of emitters 130 may include a different material (e.g., such as the third electrically conductive material as described in the foregoing). For example, the emitter tip 132 may include (e.g., be made of, or have a coating layer of) a low atomic number material such as mayenite in an electride phase, and/or strontium vanadate while the remaining bulk portion of the plurality of emitters 130 may include (e.g., be made of) a higher atomic number materials such as, for example, lanthanum hexiboride (LaB₆)).

Furthermore, as capturing excitation energy (e.g., absorbing photons) and converting the captured excitation energy into free electrons may be a primary function of the base layer 110, the base layer 110 may include different materials than the plurality of emitters 130 and/or emitter tip 132. For example, the work function of the material of the base layer 110 may be higher than that of the emitter tips 132 of the plurality of emitters 130. For example, the atomic number (Z) of the material of the base layer 110 may be greater than the atomic number of the material of the plurality of emitters 130 and/or emitter tip 132.

The plurality of support posts 140 may extend between the base layer 110 and the collector layer 120 so as to support the collector layer 120 (e.g., to maintain a spacing between the base layer 110 and the collector layer 120). The plurality of support posts 140 may be arranged on the base layer 110 and extend from the base layer 110 (e.g., from a first surface of the base layer 110) to the collector layer 120 (e.g., to a first surface of the collector layer 120 facing the first surface of the base layer 110). The plurality of support posts 140 may include uniform, or non-uniform, support posts. Although each support posts of the plurality of support posts 140 may be non-uniformly shaped, may have non-uniform geometries, may be non-uniformly spaced, may include different materials, and/or may be non-uniformly arranged in the electric generator 100, for clarity, throughout the present disclosure the plurality of support posts 140 will be described as though each support post of the plurality of support posts 140 has the same shape, geometry, spacing, materials, and arrangement.

Each support post of the plurality of support posts may contact with the base layer 110 and the collector layer 120 at opposite ends of each support post. For example, a first end 141 of the support post may be in direct physical contact (e.g., joined) with the base layer 110, and a second end 142 of the support post may be in direct physical contact (e.g., joined) with the collector layer 120. For further example, a surface of the first end 141 of the support post may be in union with, and/or form a junction with, a surface of the base layer 110, and a surface of the second end 142 of the support post may be in union with, and/or form a junction with, a surface of the collector layer 120.

Each support post of the plurality of support posts 140 has a support post height 143. The support post height 143 may be defined as a distance between the first end 141 of the support post and the second end 142 of the support post. The support post height 143 may set a distance that the base layer 110 and the collector layer 120 are spaced apart from each other. The support post height 143 may be greater than the emitter height 133 so that, with the collector layer 120 layered onto the plurality of support posts 140, an emitter gap 123 is formed between the emitter tip 132 of each emitter of the plurality of emitters 130 and the collector layer 120.

The size (e.g., distance) of the emitter gap 123 may be configured based on the size, shape, and/or material (e.g., third electrically conductive material) of the plurality of emitters 130. For example, a smaller emitter gap 123 may be selected for emitter shapes and/or materials having a larger work function. The size (e.g., distance) of the emitter gap may be configured based on expected loads that may displace components (e.g., the collector layer 120 and/or the plurality of emitters 130) of the electric generator 100 (e.g., during operation, transportation, or non-operational stages of the life of the electric generator 100). For example, a large emitter gap 123 may be selected based on higher operational loads (e.g., vibration or shock loads) so as to decrease the likelihood that the plurality of emitters 130 may physically contact the collector layer 120. The size (e.g., distance) of the emitter gap may be configured based on a desired current density of an electrical current flow through the electric generator 100 when the generator is operating. For example, a smaller emitter gap 123 size may be selected for higher current density. With these considerations in mind, the emitter gap 123 distance may be greater than or equal to about 1 nm and less than or equal to about 20 mm. For example, the emitter gap 123 distance may be between about 10 nm and about 20 mm inclusive of endpoints, or about 10 nm and about 1 mm inclusive of endpoints, or about 10 nm and about 500 μm inclusive of endpoints, or about 10 nm and about 250 μm inclusive of endpoints, or about 10 nm and about 250 μm inclusive of endpoints, or between about 20 nm and about 250 μm inclusive of endpoints, or between about 30 nm and about 250 μm inclusive of endpoints, or between about 40 nm and about 250 μm inclusive of endpoints, or between about 50 nm and about 250 μm inclusive of endpoints, or between about 100 nm and about 250 μm inclusive of endpoints, or between about 10 nm and about 200 μm inclusive of endpoints, or between about 10 nm and about 150 μm inclusive of endpoints, or between about 10 nm and about 100 μm inclusive of endpoints, or between about 10 nm and about 50 μm inclusive of endpoints, or between about 10 nm and about 25 μm inclusive of endpoints, or between about 10 nm and about 20 μm inclusive of endpoints, or between about 10 nm and about 10 μm inclusive of endpoints, or between about 10 nm and about 5 μm inclusive of endpoints, or between about 10 nm and about 3 μm inclusive of endpoints, or between about 10 nm and about 2 μm inclusive of endpoints, or between about 20 nm and about 2 μm inclusive of endpoints, or between about 50 nm and about 2 μm inclusive of endpoints, or between about 100 nm and about 2 μm inclusive of endpoints, or between about 100 nm and about 1 μm inclusive of endpoints, or greater than or equal to about 500 nm to about 100 μm, or greater than or equal to about 1 μm to less than or equal to about 100 μm, or greater than or equal to about 1 μm to less than or equal to about 75 μm, or greater than or equal to about 1 μm to less than or equal to about 50 μm, or greater than or equal to about 1 μm to less than or equal to about 40 μm, or greater than or equal to about 1 μm to less than or equal to about 30 μm, or greater than or equal to about 1 μm to less than or equal to about 25 μm, or greater than or equal to about 1 μm to less than or equal to about 20 μm, or greater than or equal to about 2 μm to less than or equal to about 75 μm, or greater than or equal to about 2 μm to less than or equal to about 50 μm, or greater than or equal to about 2 μm to less than or equal to about 40 μm, or greater than or equal to about 2 μm to less than or equal to about 25 μm, or greater than or equal to about 3 μm to less than or equal to about 50 μm.

The emitter gap 123 may be kept at a vacuum pressure (e.g., less than or equal to about 10⁻³ Torr). Alternatively, the emitter gap 123 may include gas atoms and/or molecules (e.g., such as diatomic molecules). For example, the emitter gap 123 may include Cs gas or a noble gas (e.g., gases from Group 18 of the periodic table, such as argon (Ar), krypton (Kr), xenon (Xe), radon (Rn), and the like). When a gas is included in the emitter gap 123 the pressure of the emitter gap may be higher than when the emitter gap is kept at a vacuum (e.g., greater than about 10⁻³ Torr to about 1 Torr).

The cross-sectional shape of a support post of the plurality of support posts 140 may be any shape (e.g., in the x-z plane of the FIGS). For example, the cross-sectional shape the support post may include a circle, oval, a triangle, a square, rectangle, the shape of any polygon having straight or curved sides (e.g., a multi-pointed star), and the like. Moreover, the cross-sectional shape of the support post may include intersecting line segments, such as I-shaped, T-shaped, X-shaped, and the like which may provide greater strength to weight ratio in comparison to other shapes. The cross-sectional shape of support posts of the plurality of support posts 140 may be different than the cross-sectional shape of emitters of the plurality of emitters 130. For example, the cross-sectional shape of a support post may be square while the cross-sectional shape of an emitter is a circle.

Individual support posts of the plurality of support posts 140 may surround one or more emitters of the plurality of emitters 130. For example, a cross-sectional shape of an individual support post in a direction non-parallel to a direction from the emitter base to the emitter tip (e.g., non-parallel to the y-z plane or the x-y plane in the attached figures, e.g., perpendicular to the x-z plane, e.g., cross-sectional shape in the x-z plane in the attached figures) may include a square, rectangle, circle, oval, triangle, or a shape of any polygon having straight or curved sides (e.g., as previously described) which encircles an emitter or a group of emitters of the plurality of emitters 130. In one example, individual support posts may form boxes around one or more emitters of the plurality of emitters 130. Further, individual support posts may form walls which extend along portions of the plurality of emitters 130 (e.g., in the x-z plane of the attached figures). The walls may intersect one another or may be non-intersecting.

The plurality of support posts 140 may be interspersed among the plurality of emitters 130. The plurality of support posts 140 may be arranged in a square grid pattern, a circular grid pattern, or any other pattern.

The number of support posts of the plurality of support posts 140 may be related to structural support of the collector layer 120. For example, the number of support posts of the plurality of support posts 140 may be based on a minimum distance between support posts to ensure that the collector layer 120 is sufficiently supported, so as to prevent sagging and/or bending of the collector layer 120 which may cause emitters of the plurality of emitters 130 to come into physical contact the collector layer 120. For example, during operation, elements of the electric generator 100 may be heated (e.g., causing thermal expansion), vibrated, impacted by shock loads, and/or compacted by external pressure (e.g., causing compression loading). Each of these conditions may cause displacement of the elements of the electric generator 100 which may cause emitters of the plurality of emitters 130 to come into physical contact the collector layer 120 which may result in a short circuit of the electric generator 100. To prevent such short circuit from occurring, the minimum distance between support posts of the plurality of support posts 140 may be related to the coefficient of expansion of elements of the electric generator 100 (e.g., the base layer 110, the collector layer 120, the plurality of emitters 130, and/or the plurality of support posts 140), the emitter gap 123 distance, expected shock and/or vibrational loads, expected operating pressures, and the like.

However, as each support post of the plurality of support posts 140 occupies space which could otherwise be allocated to the plurality of emitters 130, increasing the number of support posts (e.g., support posts per a unit area of the plurality of emitters 130) may decrease the number of electrons that are able to be transferred through the plurality of emitters 130 across the emitter gap 123 to the collector layer 120. Therefore, there may be a tradeoff between performance of the electric generator 100 and structural integrity/capability of the electric generator 100 (e.g., the maximum operating temperatures, shock and/or vibration loads, or maximum operating pressures). With this in mind, a minimum distance between adjacent support posts of the plurality of support posts 140 may be determined through modeling and/or testing.

Based on this tradeoff, for operation in a wide range of conditions, it has been determined that a fraction of a number of emitters of the plurality of emitters 130 divided by a number of support posts of the plurality of support posts 140 in any portion (or in the entirety) of the electric generator 100 may be less than or equal to about 500 and greater than or equal to about 5, or less than or equal to about 400 and greater than or equal to about 5, or less than or equal to about 300 and greater than or equal to about 5, or less than or equal to about 200 and greater than or equal to about 5, or less than or equal to about 100 and greater than or equal to about 5, or less than or equal to about 75 and greater than or equal to about 5, or less than or equal to about 50 and greater than or equal to about 5, or less than or equal to about 30 and greater than or equal to about 5, or less than or equal to about 25 and greater than or equal to about 5, or less than or equal to about 20 and greater than or equal to about 5. Moreover, a distance between adjacent support posts of the plurality of support posts 140 may be greater than or equal to about 500 μm and less than or equal to about 100 mm. For example, a distance between adjacent support posts of the plurality of support posts 140 may be greater than or equal to about 0.5 mm and less than or equal to about 50 mm, or greater than or equal to about 0.5 mm and less than or equal to about 25 mm, or greater than or equal to about 0.5 mm and less than or equal to about 20 mm, or greater than or equal to about 0.5 mm and less than or equal to about 10 mm, or greater than or equal to about 0.5 mm and less than or equal to about 7.5 mm, or greater than or equal to about 0.5 mm and less than or equal to about 5 mm, or greater than or equal to about 0.5 mm and less than or equal to about 3 mm, or greater than or equal to about 0.5 mm and less than or equal to about 2 mm, or greater than or equal to about 1 mm and less than or equal to about 2 mm.

The electric generator 100 may be bounded (e.g., in the x-z plane of the attached FIGS) by walls of an electrically insulative material on all sides so as to enclosed the plurality of emitters 130 within the electric generator 100. Similarly, individual cells of the electric generator 100 may be defined by electrically insulative walls disposed within a matrix of the plurality of emitters 130. In this way, the insulative walls my act as additional edge or interior support posts onto which the collector layer 120 may be layered.

The electric generator 100 may include an insulation layer 150 on the collector layer 120. For example, a first side 151 of the insulation layer 150 may be in contact (e.g., physical contact) with a first side 121 of the collector layer 120 opposite of the plurality of emitters 130. The insulation layer 150 may include another electrically insulative material so as to prevent electrons from transferring from the first side 121 of the collector layer 120 to the first side 151 of the insulation layer 150.

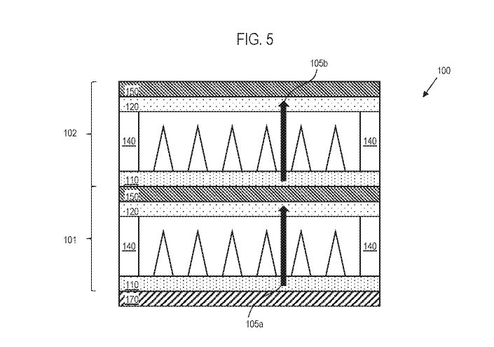

Referring to FIG. 5, the electric generator 100 may include multiple stacked layers (e.g., stacked architecture). For example, the electric generator 100 may include a first layer 101 and a second layer 102 stacked onto the first layer 101. The first layer 101 may be positioned closer to an excitation source 170 such as a radionuclide, a heat source, an electric field source, or other source of energy with sufficient to power to overcome the work function of the plurality of emitters 130. In this way, the first layer 101 may receive energy from the excitation source 170 sufficient to cause electrons to flow from the emitter tip 132 to the collector layer 120 and thereby cause a first electrical current flow path 105a. Similarly, the second layer 102 may receive energy from the excitation source 170 sufficient to cause electrons to flow from the emitter tip 132 to the collector layer 120 and thereby cause a first electrical current flow path 105b. In such a stacked, multilayer, configuration, the insulation layer 150 may be between the stacked layers so as to prevent electrons from the collector layer 120 of the first layer 101 from crossing into the base layer 110 of the second layer 102.

The plurality of support posts 140, the insulation layer 150, and/or the aforementioned walls may include (e.g., be made of) an electrically insulative material. Furthermore, the electrically insulative material may also be a thermally conductive material. For example, the electrically insulative material may include (e.g., be made of) a ceramic material including inorganic elements. For example, an electrically insulative material may include at least one of an(a) alumina, aluminum oxide, aluminum nitride, silicate, silicon oxide, silicon carbide, titanate, and the like. Utilizing an electrically insulative material which is also thermally conductive may provide a transfer path for thermal energy to move from one layer (e.g., base layer 110) to the next layer (e.g., collector layer 120), or in a stacked, multilayer, configuration, away from innermost layers (e.g., first layer 101) to outer layers (e.g., second layer 102) of the electric generator 100 and keep layers from overheating and/or deforming due to thermal stresses (e.g., which may be greater closer to the excitation source 170).

The elements of the electric generator 100 may be made by an additive manufacturing process. The base layer 110, the collector layer 120, the plurality of emitters 130, and/or the plurality of support posts 140 may be obtained by, or result from, an additive manufacturing process. For example, an additive manufacturing process may include a three-dimensional (3D) printing process such as a directed energy deposition (DED) process (e.g., including powder-fed DED and metal wire DED processes), selective powder deposition process, electron beam melting process, powder bed fusion process, additive friction stir deposition process, and the like. The additive manufacturing process may include preconfiguring the DOE device (e.g., such as a 3D printer) with parameters such as spatial orientation, relative distances between, layout, and the like of the aforementioned elements of the electric generator 100 (e.g., base layer 110, plurality of emitters 130, the plurality of support posts 140, collector layer 120, insulation layer 150, and the like). Further the preconfigured parameters may include material properties such as porosity, density, melt viscosity, directed energy temperature, melt temperature, hold time for coalescing, and the like. Still further, the preconfigured parameter may include processing aspects such as velocity per pass of the 3D printer head, directed energy temperature and/or power output. The preconfigured parameters may vary spatially throughout the build, e.g., across the build plate (e.g., in the x-z plane of the attached figures) and/or the height of the build (e.g., in the y-axis direction of the attached figures).

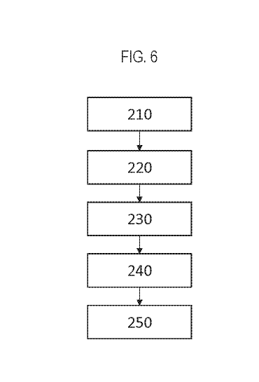

Referring to FIG. 6, a method 200 of manufacturing the electric generator 100 may include a first aspect 210 that may include layering the base layer 110 onto a work surface, a second aspect 220 that may include adding to the base layer 110 the plurality of emitters 130, a third aspect 230 that may include adding to the base layer 110 the plurality of support posts 140, a fourth aspect 240 that may include layering onto the plurality of support posts 140 the collector layer 120 so as to form the emitter gap 123 between the emitter tips of the plurality of emitters 130 and the collector layer 120, and a fifth aspect 250 that may include layering the insulation layer 150 onto the collector layer 120.

The first aspect 210 may include layering, such as placing, onto the work surface (e.g., also referred to as a build surface or build plate when manufacturing in a planar geometry) a sheet, plate, cylinder (e.g., when the electric generator 100 is to have a cylindrical geometry), or first hemisphere (e.g., when the electric generator 100 is to have a hemispherical or spherical geometry) of the first electrically conductive material to form the base layer 110. Alternatively, the first aspect 210 may include layering, such as printing, by a 3D printer, the first electrically conductive material to form the base layer 110 on the work surface. The base layer 110 being 3D printed to form a sheet (e.g., or plate, when the electric generator 100 is to have a hemispherical or spherical geometry), cylinder (e.g., when the electric generator 100 is to have a cylindrical geometry), or first hemisphere (e.g., when the electric generator 100 is to have a hemispherical or spherical geometry). The first aspect 210 may include post-processing of the layered material of the base layer 110 such as heating, compressing, and/or cooling the layered material to reduce porosity and/or coalesce the layered material. For example, post-processing the layered material may include sintering, annealing, and/or any suitable process for reducing porosity in and/or coalescing the layered material (e.g., which may include irradiating the layer material with a laser).

The second aspect 220 may include printing, by a 3D printer (e.g., a first 3D printer), the plurality of emitters 130 onto the base layer 110 of the first electrically conductive material. Each emitter of the plurality of emitters 130 may be printed to have an emitter base 131, and an emitter tip 132 extended from the emitter base 131 by an emitter height 133. The emitter base 131 may be printed directly onto the base layer 110 so that each emitter of the plurality of emitters 130 is in contact (e.g., direct physical contact) with the base layer 110, has the emitter base cross-sectional area A₁₃₁ and has the emitter tip 132 having an emitter tip cross-sectional area A₁₃₂ that is less than or equal to the emitter base cross-sectional area A₁₃₁. The plurality of emitters 130 may be printed with the third electrically conductive material, which, as discussed in the foregoing, may be the same material or a different material than the first electrically conductive material. The second aspect 220 may include post-processing of the printed plurality of emitters 130 such as heating, compressing, and/or cooling the printed plurality of emitters 130 to reduce porosity and/or coalesce the layered material. For example, post-processing the printed plurality of emitters 130 may include sintering, annealing, and/or any suitable process for reducing porosity in and/or coalescing the printed plurality of emitters 130 (e.g., which may include irradiating the printed plurality of emitters 130 with a laser).

The second aspect 220 may further include placing, such as printing (e.g., by a separate 3D printer or with a separate head of the first 3D printer configured to print a different material), a filler material between the emitters of the plurality of emitters 130. For example, before layering the collector layer 120, a filler material (e.g., a ceramic, dry powder, foam, or the like) capable of maintaining its shape under high temperature (e.g., temperature of greater than or equal to °500 C) may be layered in the space between emitters of the plurality of emitters 130 as the 3D printing builds up layers of the plurality of emitters 130. As the 3D printing progresses, and once the emitter tips of the plurality of emitters 130 are completed by the 3D printing, the filler material may be layered above the emitters so as to fill the emitter gap 123 until the collector layer 120 is layered onto the plurality of support posts 140. In this way, the collector layer 120 may be 3D printed onto a level surface including the filler material (e.g., layered in the emitter gap 123 above the plurality of emitters 130) and the plurality of support posts 140. Following the layering of the collector layer 120, the filler material may be removed from between the plurality of emitters 130 and the emitter gap 123 by a number of different techniques including blowing (e.g., with compressed air or other gas), vaporizing the filler material by heating above a vaporization temperature of the filler material, dissolving the filler material in a solvent (e.g., water, acetone, and the like), washing the filler material out of the electric generator 100 with a solvent (e.g., water, acetone, and the like), centrifuging the filler material out of the electric generator 100, and the like. The second aspect 220 may include post-processing the filler material placed between the emitters of the plurality of emitters 130 such as heating, compressing, and/or cooling the placed filler material to reduce porosity and/or coalesce the layered material. For example, post-processing the placed filler material may include sintering, annealing, and/or any suitable process for reducing porosity in and/or coalescing the placed filler material (e.g., which may include irradiating the placed filler material with a laser).

The third aspect 230 may include printing, by a 3D printer (e.g., a second 3D printer) the plurality of support posts 140 including the electrically insulative material onto the base layer 110. Each support post of the plurality of support posts 140 may be in contact (e.g., direct physical contact) with the base layer 110 at the first end 141 of each support post. Each support post of the plurality of support posts 140 may have a support post height 143 which may be greater than the emitter height 133. The third aspect 230 may include post-processing of the printed plurality of support posts 140 such as heating, compressing, and/or cooling the printed plurality of support posts 140 to reduce porosity and/or coalesce the printed plurality of support posts 140. For example, post-processing the printed plurality of support posts 140 may include sintering, annealing, and/or any suitable process for reducing porosity in and/or coalescing the printed plurality of support posts 140 (e.g., which may include irradiating the printed plurality of support posts 140 with a laser).

The third aspect 230 may further include placing, such as printing (e.g., by a separate 3D printer or with a separate head of the second 3D printer configured to print a different material), the filler material between the support posts of the plurality of support posts 140. For example, before layering the collector layer 120, the filler material may be layered in the space between emitters of the plurality of emitters 130 and the space between support posts of the plurality of support posts 140 (and between support posts and emitters) as the 3D printing builds up layers of the plurality of support posts 140. As the 3D printing progresses, the filler material may be layered above the emitters so as to fill the emitter gap 123 until the collector layer 120 is layered onto the plurality of support posts 140. In this way, the collector layer 120 may be 3D printed onto a level surface including the filler material (e.g., layered in the emitter gap 123 above the plurality of emitters 130) and the plurality of support posts 140. Following the layering of the collector layer 120, the filler material may be removed from between the plurality of emitters 130, between the plurality of support posts 140, and the emitter gap 123 by a number of different techniques as discussed in the foregoing. The third aspect 230 may include post-processing the filler material placed between the support posts of the plurality of support posts 140 such as heating, compressing, and/or cooling the placed filler material to reduce porosity and/or coalesce the layered material. For example, post-processing the placed filler material may include sintering, annealing, and/or any suitable process for reducing porosity in and/or coalescing the placed filler material (e.g., which may include irradiating the placed filler material with a laser).

The second aspect 220 and the third aspect 230 may be performed simultaneously or sequentially. Regarding a sequential operation, the base layer 110 could be printed first, the plurality of emitters 130 and the plurality of support posts 140 printed next (e.g., either simultaneously, or sequentially, with the plurality of emitters 130 printed first and the plurality of support posts 140 printed next or vice versa), and finally the collector layer 120 could be printed last. Further, the printing of both the plurality of emitters 130 and plurality of support posts 140 could be done together (e.g., semi-simultaneously) with the heights of each being built up layer by layer until each emitter tip 132 of the plurality of emitters 130 is completed leaving the remaining portions of the plurality of support posts 140 to be printed before moving to the fourth aspect 240. Further, filler material may be placed between emitters of the plurality of emitters 130 and/or between support posts of the plurality of support posts 140 simultaneously with the printing of the emitters of the plurality of emitters 130 and/or support posts of the plurality of support posts 140. Alternatively, or in addition, at least portions of the filler material may be placed between emitters of the plurality of emitters 130 and/or between support posts of the plurality of support posts 140 serially (e.g., filler material may be placed after emitters of the plurality of emitters 130 and/or support posts of the plurality of support posts 140 are printed (e.g., partially or completely formed)). Still further, the aforementioned post processing of emitters of the plurality of emitters 130, support posts of the plurality of support posts 140, filler material placed between emitters of the plurality of emitters 130, and/or filler material placed between the support posts of the plurality of support posts 140 such as heating, compressing, and/or cooling to reduce porosity and/or coalesce the material or each aforementioned element of the electric generator 100 may be done simultaneously (e.g., by heating/cooling two or more, or all the aforementioned elements together) or serially (e.g., after the formation of each aforementioned element).

The first 3D printer and the second 3D printer may be the same 3D printer, may be two separate 3D printers, or two separate elements (e.g., printing heads) of the same 3D printing device.

The fourth aspect 240 may include layering the collector layer 120 including the second electrically conductive material onto the second end 142 of support posts of the plurality of support posts 140 opposite the first end 141 so that, with the collector layer 120 layered onto the plurality of support posts 140, an emitter gap 123 between the emitter tip 132 of each emitter of the plurality of emitters 130 and the collector layer 120 is formed. As discussed in the foregoing with reference to placing a filler material in the spaces between the plurality of emitters 130 and plurality of support posts 140, the layering of the collector layer 120 may include printing, by a 3D printer (e.g., by a separate 3D printer or with a separate head of the first 3D printer configured to print a different material), the collector layer 120 onto the second end 142 of the plurality of support posts 140 and the filler material which fills the emitter gap 123 and provides a level work surface on which the collector layer 120 may be printed. The fourth aspect 240 may include post-processing of the layered material of the collector layer 120 such as heating, compressing, and/or cooling the layered material to reduce porosity and/or coalesce the layered material. For example, post-processing the layered material may include sintering, annealing, and/or any suitable process for reducing porosity in and/or coalescing the layered material (e.g., which may include irradiating the layer material with a laser).

A fifth aspect 250 may include layering the insulation layer 150 onto the collector layer 120. For example, the layering may include placing, such as printing, by a 3D printer, a layer of the electrically insulative material to form the insulation layer 150 on the collector layer 120 so that a first side 151 of the insulation layer 150 is in contact (e.g., direct physical contact) with the first side 121 of the collector layer 120. The fifth aspect 250 may include post-processing of the layered material of the insulation layer 150 such as heating, compressing, and/or cooling the layered material to reduce porosity and/or coalesce the layered material. For example, post-processing the layered material may include sintering, annealing, and/or any suitable process for reducing porosity in and/or coalescing the layered material (e.g., which may include irradiating the layer material with a laser).

Once the electric generator 100 is formed, based on an excitation as discussed in the foregoing, electrons in the base layer 110 may move to the emitter tip 132 (e.g., which may thereby increase an electron density at the emitter tip 132), and the electrons then may travel across the emitter gap 123 to the collector layer 120 so as to form an electrical current flow path 105 between the plurality of emitters 130 and the collector layer 120.

Alternatively, in the first aspect 210, the layering of the first electrically conductive material to form the base layer 110 may include printing, by a 3D printer (e.g., a third 3D printer), the base layer 110 onto a substrate (e.g., a removable substrate or work surface from which the base layer 110 is removable). In this way, the base layer 110, the collector layer 120, the plurality of emitters 130, and the plurality of support posts 140 may all be printed by a 3D printing process.

The electric generator 100 may be operated by exposing the electric generator 100 to an energy source that has sufficient energy to cause an excitation of the base layer 110 and/or plurality of emitters 130 so as to cause electrons to move across the emitter gap 123. For example, the electric generator 100 may be operated by exposing the electric generator 100 to a radionuclide configured to emit gamma radiation sufficient to cause an excitation of the base layer 110 and/or plurality of emitters 130. In another example, the electric generator 100 may be operated by exposing the electric generator 100 to a high energy photon source (e.g., x-ray, cosmic ray, and the like, having photon energies of greater than or equal to about 3 eV (e.g., ultra-violet (UV) radiation), or greater than or equal to about 100 eV (e.g., x-rays), or greater than or equal to about 1 keV) sufficient to cause an excitation of the base layer 110 and/or plurality of emitters 130. In another example, the electric generator 100 may be operated by exposing the electric generator 100 to a thermal process which emits electromagnetic radiation sufficient to cause an excitation of the base layer 110 and/or plurality of emitters 130. Such a thermal process may include exposing the electric generator 100 to a high temperature environment (e.g., temperatures of greater than or equal to about 450°C, or greater than or equal to about 500°C) such as an exhaust stream of an engine (e.g., jet engine, internal combustion engine, and the like), an industrial process (e.g., furnaces), a high temperature portion of a nuclear reactor, and the like. In another example, the electric generator 100 may be operated by exposing the electric generator 100 to an electromagnetic radiation source (e.g., light source such as ultraviolet, infrared, and/or visible light, radio or microwave, and the like). For example, the base layer 110 may include transparent material configured to allow penetration of light which may cause excitation of the base layer 110 and/or plurality of emitters 130 so as to cause electrons to move across the emitter gap 123.

Furthermore, operating the electric generator 100 may include connecting the cells of the electric generator in series with an electrical load. For example, operating the electric generator 100 may include connecting a first electrical conductor (e.g., a wire capable to transferring electrical current therethrough) to the base layer 110, connecting a second electrical conductor to the collector layer 120, connecting a first terminal (e.g., a negative terminal configured to receive a flow a electrons) of an energy consumer (e.g., any device that consumes electrical energy) to the first electrical conductor and a second terminal (e.g., a positive terminal configured to discharge a flow of electrons from the energy consumer) of the energy consumer to the second electrical conductor so as to form an electrical circuit including the base layer 110, the plurality of emitters 130, the emitter gap 123, the collector layer 120, the second electrical conductor, the energy consumer, and the first electrical conductor. Once connected in this way, an excitation of the electric generator 100 may cause electrons to move to the emitter tip 132 (e.g., which may thereby increase an electron density at the emitter tip 132), move across the emitter gap 123 to the collector layer 120, move through the second electrical conductor, move through the energy consumer, move through the first electrical conductor, and then move back to the base layer 110 so as to travel along the electrical circuit.

The above-described serial arrangement may be extrapolated to a multi-layered electric generator 100 (as shown in FIG. 5). In this case, a collector layer 120 from the first layer 101 may be electrically connected to a base layer 110 of the second layer 102 so that electrons may flow serially through each layer. For example, the operating the electric generator 100 may include connecting the first electrical conductor to the base layer 110 of the first layer 101, connecting the second electrical conductor to the collector layer 120 of the second layer 102 (or subsequently stacked layer), connecting the collector layer 120 of the first layer 101 to the base layer 110 of the second layer 102 (or otherwise configuring the collector layer 120 of the first layer 101 and the base layer 110 of the second layer 102 to be in electrical communication), connecting a first terminal (e.g., a negative terminal configured to receive a flow a electrons) of an energy consumer (e.g., any device that consumes electrical energy) to the first electrical conductor and a second terminal (e.g., a positive terminal configured to discharge a flow of electrons from the energy consumer) of the energy consumer to the second electrical conductor so as to form an serially arranged electrical circuit including the base layer 110 of the first layer 101, the plurality of emitters 130 of the first layer 101, the emitter gap 123 of the first layer 101, the collector layer 120 of the first layer 101, another base layer 110 of the second layer 102, another plurality of emitters 130 of the second layer 102, another emitter gap 123 of the second layer 102, another collector layer 120 of the second layer 102, the second electrical conductor, the energy consumer, and the first electrical conductor. The described serial arrangement may be continued for a mulit-layered electric generator 100 having any number of layers n layers where there may be n layers-1 interconnections between adjacent collector layers 120 and base layers 110.

Alternatively, or in addition, the electric generator 100 may be configured with a parallel arrangement. In this case, the described layers (e.g., first layer 101 and second layer 102) may be electrically isolated from one another and electron flow from each layer may independently tapped. Furthermore, the first layer 101 and second layer 102 may be adjacent (e.g., horizontally shifted from one another in the x-z plane of the attached figures so as to form a shifted architecture) and/or stacked as previously described. For example, the operating the electric generator 100 may include connecting the first electrical conductor to the base layer 110 of the first layer 101, connecting the second electrical conductor to the collector layer 120 of the first layer 101, connecting a third electrical conductor to the base layer 110 of the second layer 102, connecting a fourth electrical conductor to the collector layer 120 of the second layer 102, connecting a first terminal of an energy consumer to the first electrical conductor and third electrical conductor, connecting the second terminal of the energy consumer to the second electrical conductor and the fourth electrical conductor so as to form an electrical circuit arranged in parallel where the first electrical conductor, the base layer 110 of the first layer 101, the plurality of emitters 130 of the first layer 101, the emitter gap 123 of the first layer 101, the collector layer 120 of the first layer 101, and the second electrical conductor form a first electron flow path to the energy consumer and the third electrical conductor, another base layer 110 of the second layer 102, another plurality of emitters 130 of the second layer 102, another emitter gap 123 of the second layer 102, another collector layer 120 of the second layer 102, and the fourth electrical conductor form a second electron flow path to the energy consumer (which is separate, and/or isolatable, from the first flow path). The described parallel arrangement may be continued for a mulit-layered electric generator 100 having any number of layers n layers where there may be 2*n layers electrical conductors (e.g., two for each layer of the multi-layered electric generator 100) and/or n layers electrical flow paths (e.g., one flow path for each layer).

Alternatively, or in addition, the electric generator 100 may be configured with a mixture of serially arranged layers and parallel arranged layers. In this way, some layers of the electric generator can be arranged in electrical series and other layers can be arranged in parallel electrically. As both series and parallel arrangements are described in the foregoing, the mixed arrangement of series and parallel will not be again described here.

The disclosed examples may be implemented as an apparatus (a machine) that includes processing hardware configured, for example, by way of software executed by the processing hardware and/or by hardware logic circuitry, to perform the described features, functions, operations, processes, methods, steps, and/or benefits.

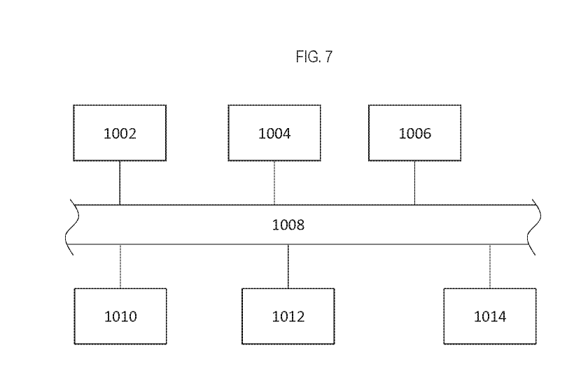

The disclosed examples may include a computing apparatus, such as (in a non-limiting example) any computer or computer processor, that includes processing hardware and/or software implemented on the processing hardware to transmit and receive (communicate (network) with other computing apparatuses), store and retrieve from computer readable storage media, process and/or output data. According to an aspect of an example, the described features, functions, operations, processes, methods, steps, and/or benefits may be implemented by and/or use processing hardware and/or software executed by processing hardware. For example, a computing apparatus as illustrated in FIG. 7 may include a central processing unit (CPU) or a computing processing system 1004 (e.g., one or more processing devices (e.g., chipset(s), including memory, etc.) that may process or execute instructions, namely software, program(s), and/or application(s), which may be stored in a memory 1006 and/or a computer readable storage media 1012 (e.g., read-only memory (ROM), flash memory, hard disk, solid state memory, and the like), transmission communication interface 1010 (e.g., network interface, wire/wireless data network interface), input device 1014 (e.g., mouse, keyboard, multi-touch display, audio microphone, sensor, and the like), and/or an output device 1002, for example, a display device (e.g., multi-touch display, audio speaker, visual display, and the like), a printing device, and which are coupled (directly or indirectly) to each other, for example, may be in communication among each other through one or more data communication buses 1008.

In an example, the computing apparatus may be a controller configured to control the electric generator 100. For example, the controller may be configured to control the flow of electrons from the collector layer 120 to produce an electric current. For example, the controller may be configured to meter the flow of electrons from the base layer 110 to the collector layer 120 such as by controlling a forward and/or reverse bias voltage of the field emission electrode 180 to correspondingly increase or decrease (or even stop) electron flow from the base layer 110 to the collector layer 120. The controller may be configured to control the flow of high energy photons (e.g., UV radiation, x-ray radiation, radiation from a radionuclide, and the like), a temperature of a heat source, a flow rate of a heat source, a distance that the electric generator 100 is positioned from a heat source, a strength of an electric field, a distance that the electric generator 100 is positioned from an electric field, a direction of a force applied by an electric field, or the like so as to correspondingly control a flow of electrons from the base layer 110 across the emitter gap 123 to the collector layer 120. The controller may be configured to control the heat source, electric field, and/or electric generator 100 so as to balance the rates of electrons liberated from the plurality of emitters 130 to correspond to the rate of electrical current output from the collector layer 120.

In addition, an apparatus may include one or more apparatuses in computer network communication with each other or other apparatuses and the examples relate to control and/or communication of aspects of the disclosed features, functions, operations, processes, methods, steps, and/or benefits, for example, data or information involving local area network (LAN) and/or Intranet based computing, cloud computing in case of Internet based computing, Internet of Things (IoT) (network of physical objects – computer readable storage media (e.g., databases, knowledge bases), devices (e.g., appliances, cameras, mobile phones), vehicles, buildings, and other items, embedded with electronics, software, sensors that generate, collect, search (query), process, and/or analyze data, with network connectivity to exchange the data), online websites. In addition, a computer processor may refer to one or more computer processors in one or more apparatuses or any combinations of one or more computer processors and/or apparatuses. An aspect of an example relates to causing and/or configuring one or more apparatuses and/or computer processors to execute the described operations. The results produced may be output to an output device, for example, displayed on the display or by way of audio/sound. An apparatus or device refers to a physical machine that performs operations by way of electronics, mechanical processes, for example, electromechanical devices, sensors, a computer (physical computing hardware or machinery) that implement or execute instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.) – collectively referred to as hardware processor(s), to achieve the functions or operations being described. The functions of embodiments described may be implemented in a type of apparatus that may execute instructions or code.

More particularly, programming or configuring or causing an apparatus or device, for example, a computer, to execute the described functions of examples of the disclosure creates a new machine where in case of a computer a general-purpose computer in effect becomes a special purpose computer once it is programmed or configured or caused to perform particular functions of the examples of the disclosure pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable storage media, e.g., a non-transitory or persistent computer-readable storage medium. Examples of the non-transitory computer-readable media include a magnetic recording apparatus, an optical disk, a magneto-optical disk, and/or volatile and/or non-volatile semiconductor memory (for example, random access memory (RAM), ROM, etc.). Examples of the magnetic recording apparatus include a hard disk device (HDD), a flexible disk (FD), and a magnetic tape (MT). Examples of the optical disk include a DVD (Digital Versatile Disc), DVD-Read-only memory (DVD-ROM), DVD-Random Access Memory (DVD-RAM), BD (Blue-ray Disk), a Compact Disc (CD) - Read Only Memory (CD-ROM), a CD-Recordable (CD-R) and/or CD-Rewritable (CD-RW). The program/software implementing the embodiments may be transmitted over a transmission communication path, e.g., a wire and/or a wireless network implemented via hardware. An example of communication media via which the program/software may be sent includes, for example, a carrier-wave signal.

The various examples described herein serve as examples of aspects of the disclosure and should not be interpreted as to limit the scope of the disclosed invention.

While various inventive examples have been described and illustrated herein, those of ordinary skill in the art will readily envision a variety of other means and/or structures for performing the function(s) and/or obtaining the result(s) and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific inventive examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, and/or kit described herein. In addition, any combination of two or more such features, systems, articles, materials, and/or kits, if such features, systems, articles, materials, and/or kits, are not mutually inconsistent, is included within the inventive scope of the present disclosure. It is to be understood that a singular form of a noun corresponding to an item may include one or more of the items, unless the relevant context clearly indicates otherwise.

As used herein, each of the phrases “A or B,” “at least one of A and B,” “at least one of A or B,” “A, B or C,”, A, B, and C”, “at least one of A, B, and C,” and “at least one of A, B, or C” may include any one of the listed items, or all possible combinations thereof. For example, use of “at least one of” preceding a group of items should be interpreted in a disjunctive way with respect to the group of items, e.g., so that presence of one item of the group meets the meaning of the recitation.

The words “a,” “an” and “the” are intended to include plural forms of elements unless specifically referenced as a single element. The term “at least” preceding a listing of elements denotes any one or any combination of the elements in the listing. In other words, the expression “at least one of …” when preceding a list of elements, modifies the entire list of elements and does not modify the individual elements of the list.

The term “and/or” includes a combination of a plurality of related listed components, or any component among the plurality of related listed components.

Terms such as “first,” “second,” or “first” or “second” may be used simply to distinguish one component from other components, and do not limit the components in other aspects (e.g., importance or order).

Further, terms such as “front”, “rear”, “top”, “bottom”, “side”, “left”, “right”, “upper”, and “lower” used in the present disclosure are defined based on the drawings, and the shape and location of each component are not limited by the terms.

The term “comprise(ing)”, “include(ing)” or “have(ing)” is intended to indicate the presence of a characteristic, number, step, operation, process, component, part, feature, function, and/or element, or any combination thereof described in the present document, and the possibility of the presence or addition of one or more other characteristics, numbers, steps, operations, processes, components, parts, features, functions, and/or elements, or any combination thereof is not precluded.

When a component is described as “connected,” “coupled,” “supported,” or “in contact” with another component, this may include not only cases in which components are directly physically connected, coupled, supported, or in contact with each other, but also cases in which they are indirectly connected, coupled, supported, or in contact through a third component.

When a component is disposed “on” another component, this includes not only a case in which the component is in contact with another component, but also a case in which still another member is present between the two components.

A term, such as “about” or “substantially,” is used at a corresponding numerical value or used as a meaning close to the numerical value when e.g., manufacturing and material tolerances which may be inherent in the stated meaning are presented. In particular, as used herein, the terms “about” and “approximately” refer to values that are plus or minus ten percent of the base value. That is, for example, reference to “about 100” or “approximately 100” refers to “90-110” inclusive. In some examples, “about” may refer to plus or minus five percent of the base value, or plus or minus two percent of the base value.

What is claimed is:

1. An electric generator comprising:
a base layer including a first electrically conductive material;
a collector layer including a second electrically conductive material;
a plurality of emitters formed by 3D printing between the base layer and the collector layer,
each emitter of the plurality of emitters having an emitter base, and an emitter tip extended from the emitter base by an emitter height,
the emitter base being in contact with the base layer and having an emitter base cross-sectional area, and
the emitter tip having an emitter tip cross-sectional area that is less than or equal to the emitter base cross-sectional area,
wherein the plurality of emitters include a third electrically conductive material; and
a plurality of support posts extended between the base layer and the collector layer,
each support post of the plurality of support posts:
in contact with the base layer and the collector layer at opposite ends of each support post,
including an electrically insulative material, and
having a support post height greater than the emitter height so as to form an emitter gap between the emitter tip of each emitter of the plurality of emitters and the collector layer,
wherein each emitter of the plurality of emitters is configured so that, based on an excitation, electrons in the base layer move to the emitter tip, and the electrons then travel across the emitter gap to the collector layer so as to form an electrical current flow path between the plurality of emitters and the collector layer.

2. The electric generator as in claim 1, wherein
each emitter of the plurality of emitters includes an aspect number of the emitter height divided by an average width of each emitter, and
each emitter of the plurality of emitters has an aspect number that is greater than or equal to about 2.

3. The electric generator of claim 1, wherein at least two of the first electrically conductive material, the second electrically conductive material, and the third electrically conductive material include different materials.

4. The electric generator of claim 1, wherein a fraction of a number of emitters of the plurality of emitters divided by a number of support posts of the plurality of support posts is less than or equal to about 100 and greater than or equal to about 5.

5. The electric generator of claim 1, wherein
support posts of the plurality of support posts are interspersed among the plurality of emitters, and
a distance between each support post of the plurality of support posts is greater than or equal to about 0.5 mm and less than or equal to about 10 mm.

6. The electric generator of claim 1, wherein a support post of the plurality of support posts has a cross-sectional shape in a plane non-parallel to a direction from the emitter base to the emitter tip of a square, rectangle, circle, a triangle, an oval, or a polygon having straight or curved sides such that the support post at least partially surrounds one or more emitters of the plurality of emitters.

7. The electric generator of claim 1, wherein the emitter gap has a gap distance that is greater than or equal to about 10 nm and less than or equal to about 20 mm.

8. The electric generator of claim 1, wherein at least one of the first electrically conductive material and the third electrically conductive material include mayenite in an electride phase.

9. The electric generator of claim 1, wherein at least one of the first electrically conductive material and the third electrically conductive material include strontium vanadate.

10. The electric generator of claim 1, further comprising:
an insulation layer, wherein a first side of the insulation layer is in contact with a side of the collector layer opposite of the plurality of emitters, the insulation layer including another electrically insulative material so as to prevent electrons from transferring from the side of the collector layer to the first side of the insulation layer.

11. The electric generator of claim 1, further comprising:
a field emission electrode between the base layer and the collector layer and including a plurality of openings respectively corresponding to the plurality of emitters and configured so that at least a portion of each emitter of the plurality of emitters passes through each opening of the plurality of openings.

12. A method comprising:
by at least one 3D printer,
printing a plurality of emitters onto a base layer of a first electrically conductive material, each emitter of the plurality of emitters having an emitter base, and an emitter tip extended from the emitter base by an emitter height, the emitter base being in contact with the base layer and having an emitter base cross-sectional area, and the emitter tip having an emitter tip cross-sectional area that is less than or equal to the emitter base cross-sectional area, wherein the plurality of emitters include a third electrically conductive material; and
printing a plurality of support posts including an electrically insulative material, onto the base layer, each support post of the plurality of support posts being in contact with the base layer at a first end of each support post, each support post of the plurality of support posts having a support post height greater than the emitter height;
layering a collector layer including a second electrically conductive material onto a second end of the plurality of support posts opposite the first end so that, with the collector layer layered onto the plurality of support posts, an emitter gap between the emitter tip of each emitter of the plurality of emitters and the collector layer is formed, and so that, based on an excitation, electrons in the base layer move to the emitter tip, and the electrons then travel across the emitter gap to the collector layer so as to form an electrical current flow path between the plurality of emitters and the collector layer.

13. The method of claim 12, further comprising layering an insulating layer including an electrically insulative material onto the collector layer.

14. The method of claim 12, further comprising:
before the layering the collector layer, layering a filler material in spaces between emitters of the plurality of emitters and/or between support posts of the plurality of support posts; and
removing the layered filler material from the spaces after the layering the collector layer.

15. A method of operating an electric generator including a base layer including a first electrically conductive material; a collector layer including a second electrically conducive material; a plurality of emitters between the base layer and the collector layer, each emitter of the plurality of emitters having an emitter base, and an emitter tip extended from the emitter base by an emitter height, the emitter base being in contact with the base layer and having an emitter base cross-sectional area, and the emitter tip having an emitter tip cross-sectional area that is less than or equal to the emitter base cross-sectional area, wherein the plurality of emitters include a third electrically conductive material and are obtained by 3D printing; the electric generator further including a plurality of support posts extended between the base layer and the collector layer, each support post of the plurality of support posts in contact with the base layer and the collector layer at opposite ends of each support post, including an electrically insulative material, and having a support post height greater than the emitter height so as to form an emitter gap between the emitter tip of each emitter of the plurality of emitters and the collector layer, the method comprising:
connecting a first electrical conductor to the base layer;
connecting a second electrical conductor to the collector layer;
connecting a first terminal of an energy consumer to the first electrical conductor and connecting a second terminal of the energy consumer to the second electrical conductor so as to form an electrical circuit including, in order, the base layer, the plurality of emitters, the emitter gap, the collector layer, the second electrical conductor, the energy consumer, and the first electrical conductor; and
exposing the base layer to an excitation so that electrons in the base layer move to the emitter tip, move across the emitter gap to the collector layer, move through the second electrical conductor, move through the energy consumer, move through the first electrical conductor, and then move back to the base layer so as to form a flow of electrical current that travels along the electrical circuit.

16. The method of claim 15, wherein the excitation includes at least one of a heat source, an electric field, and a high energy photon radiation source.

17. The method of claim 15, wherein the electric generator further includes a field emission electrode between the base layer and the collector layer and including a plurality of openings respectively corresponding to the plurality of emitters and configured so that at least a portion of each emitter of the plurality of emitters passes through each opening of the plurality of openings, and the method further includes:
applying a voltage to the field emission electrode so as to control movement of electrons across the emitter gap and thereby control the flow of electrical current along the electrical circuit.

18. The method of claim 15, wherein
the electric generator includes a multilayer stacked architecture so that the base layer further includes a first base layer and a second base layer, the collector layer further incudes a first collector layer electrically connected to the second base layer and a second collector layer, the plurality of emitters includes a first plurality of emitters between the first base layer and the first collector layer and a second plurality of emitters between the second base layer and the second collector layer, and the emitter gap includes a first emitter gap between the first plurality of emitters and the first collector layer and a second emitter gap between the second plurality of emitters and the second collector layer,
the connecting the first electrical conductor to the base layer incudes connecting the first electrical conductor to the first base layer,
the connecting the second electrical conductor to the collector layer incudes connecting the second electrical conductor to the second collector layer,
the connecting the first terminal of the energy consumer to the first electrical conductor and the connecting the second terminal of the energy consumer to the second electrical conductor forms an electrical circuit including, in order, the first base layer, the first plurality of emitters, the first emitter gap, the first collector layer, the second base layer, the second plurality of emitters, the second emitter gap, the second collector layer, the second electrical conductor, the energy consumer, and the first electrical conductor, and
exposing includes exposing at least the first base layer to an excitation so that electrons in the first base layer move across the first emitter gap to the first collector layer, move from the first collector layer to the second base layer, move from the second base layer across the second emitter gap to the second collector layer, move through the second electrical conductor, move through the energy consumer, move through the first electrical conductor, and then move back to the first base layer so as to form the flow of electrical current that travels serially along the electrical circuit.

19. The method of claim 15, wherein
the electric generator includes a stacked or shifted architecture so that the base layer further includes a first base layer and a second base layer, the collector layer further incudes a first collector layer and a second collector layer, the plurality of emitters includes a first plurality of emitters between the first base layer and the first collector layer and a second plurality of emitters between the second base layer and the second collector layer, and the emitter gap includes a first emitter gap between the first plurality of emitters and the first collector layer and a second emitter gap between the second plurality of emitters and the second collector layer, the first base layer, the first collector layer, the first plurality of emitters, and the first emitter gap are electrically isolated from the second base layer, the second collector layer, the second plurality of emitters, and the second emitter gap,
the connecting the first electrical conductor to the base layer incudes connecting the first electrical conductor to the first base layer,
the connecting the second electrical conductor to the collector layer incudes connecting the second electrical conductor to the first collector layer,
the method further includes:
connecting a third electrical conductor to the second base layer,
connecting a fourth electrical conductor to the second collector layer,
connecting the first terminal of the energy consumer to the first electrical conductor and the third electrical conductor and connecting the second terminal of the energy consumer to the second electrical conductor and the fourth electrical conductor forms two parallel electrical circuits including a first electrical circuit including, in order, the first base layer, the first plurality of emitters, the first emitter gap, the first collector layer, the second electrical conductor, the energy consumer, and the first electrical conductor, and a second electrical circuit including, in order, the second base layer, the second plurality of emitters, the second emitter gap, the second collector layer, the fourth electrical conductor, the energy consumer, and the third electrical conductor, and
exposing includes exposing the first base layer and the second base layer to an excitation so that
electrons in the first base layer move across the first emitter gap to the first collector layer, move through the second electrical conductor, move through the energy consumer, move through the first electrical conductor, and then move back to the first base layer so as to form a first flow of electrical current that travels along the electrical circuit, and
electrons in the second base layer move across the second emitter gap to the second collector layer, move through the fourth electrical conductor, move through the energy consumer, move through the third electrical conductor, and then move back to the second base layer so as to form a second flow of electrical current that travels along the electrical circuit and that is at least partially parallel to the first flow of electrical current.
